(19) United States
(12) Patent Application Publication
(10) Pub. No.: US 2020/0045388 A1
(43) Pub. Date: Feb. 6, 2020

(54) OPTICAL COMMUNICATION DEVICE AND OPTICAL COMMUNICATION SYSTEM

(71) Applicants: National Institute of Advanced Industrial Science and Technology, Tokyo (JP); NEC CORPORATION, Tokyo (JP)

(72) Inventors: Kiyo ISHII, Ibaraki (JP); Shu NAMIKI, Ibaraki (JP); Shigeyuki YANAGIMACHI, Tokyo (JP); Hitoshi TAKESHITA, Tokyo (JP); Akio TAJIMA, Tokyo (JP)

(73) Assignees: National Institute of Advanced Industrial Science and Technology, Tokyo (JP); NEC CORPORATION, Tokyo (JP)

(21) Appl. No.: 16/499,497

(22) PCT Filed: Mar. 30, 2018
(86) PCT No.: PCT/JP2018/013749

§ 371 Date: Sep. 30, 2019

(30) Foreign Application Priority Data
Mar. 31, 2017 (JP) 2017-070713

(51) Int. Cl. H04Q 11/00

(52) U.S. Cl. CPC H04Q 11/0062; H04Q 11/0005; H04Q 2011/0041; H04Q 2011/0088; H04Q 2011/0049; H04Q 2011/0084

(57) ABSTRACT

Provided are an optical communication device and an optical communication system capable of preventing the costs of equipment from increasing for an optical communication network constructed including devices provided by different vendors or devices of different generations. An optical communication device 10 includes a plurality of optical transponders 15a, 15b, 15c, and 15d configured to perform mutual conversion between an optical signal and an electrical signal; a noise addition unit 14 configured to add noise that degrades signal quality to an input optical signal and output the resulting optical signal; a first optical switch configured to output an optical signal input from outside or the noise addition unit 14 to at least one of the plurality of optical transponders 15a, 15b, 15c, and 15d; and a second optical switch configured to directly or indirectly output an optical signal input from the at least one of the plurality of optical transponders 15a, 15b, 15c, and 15d to outside or the noise addition unit 14.

### TECHNICAL FIELD

The present invention relates to an optical communication device and an optical communication system.

### BACKGROUND ART

Conventionally, an optical communication network may be constructed from devices of a single generation provided by a single vendor, and a network including devices provided by another vendor or devices of another generation may be treated as another network domain.

Non-Patent Document 1 below discloses a disaggregation system in which devices of different vendors or devices of different generations to be operated are included in a single domain optical communication network.

### CITATION LIST

### Non Patent Document

Non-Patent Document 1: M. D. Leenheere, et al., “Open and Programmable Metro Networks,” in Proc. OFC 2016, Paper Th1A.7

### SUMMARY

### Technical Problem

When an optical communication network is constructed from devices of a single-vendor and a single-generation, it may be necessary to introduce multifunctional devices having functions that are not actually used, which may increase the costs of equipment for constructing the optical communication network. In this respect, allowing devices provided by different vendors or devices of different generations to be included in the optical communication network makes it possible to introduce devices having necessary and sufficient functions depending on the application, thereby reducing the costs of equipment for constructing the optical communication network.

However, including devices provided by different vendors or devices of different generations in the optical communication network results in a great increase in the number of combinations of vendors or generations of devices between which communication is performed, thereby making it difficult to assure the communication quality between the devices. Here, it is conceivable to sufficiently enhance the communication performance of all devices so that the communication quality becomes a certain level or higher regardless of the combination of devices.

However, introducing such devices increases the costs of equipment, and impairs the advantage of including devices provided by different vendors and devices of different generations in the optical communication network.

Therefore, an object of the present invention is to provide an optical communication device and an optical communication system capable of preventing the costs of equipment from increasing for an optical communication network constructed including devices provided by different vendors or devices of different generations.

### Solution to Problem

An optical communication device according to an aspect of the present invention includes a plurality of optical transponders configured to perform mutual conversion between an optical signal and an electrical signal; a noise addition unit configured to add noise that degrades signal quality to an input optical signal and output the resulting optical signal; a first optical switch configured to output an optical signal input from outside or the noise addition unit to at least one of the plurality of optical transponders; and a second optical switch configured to directly or indirectly output an optical signal input from the at least one of the plurality of optical transponders to outside or the noise addition unit.

According to this aspect, the noise addition unit adding noise to the optical signal transmitted between the plurality of optical transponders on purpose makes it possible to measure the communication quality on demand for an optical communication network constructed including devices provided by different vendors or devices of different generations. Therefore, it is possible to specify a combination of devices having communication quality of a certain level or more, and to introduce devices having various performances, and thus it is possible to prevent the costs of equipment from increasing.

In the above aspect, the optical communication device may further include a third optical switch configured to output the input optical signal to the noise addition unit. The first optical switch may output the optical signal input from the outside or the noise addition unit to one of the plurality of optical transponders or the third switch, and the second optical switch may output the optical signal input from one of the plurality of optical transponders to the outside or the third optical switch.

According to this aspect, including the third optical switch to which the optical signal is input from the first optical switch makes it possible to add noise to the optical signal input from the outside and transmit the resulting optical signal to the optical transponder. Therefore, it is possible to easily measure the communication quality between optical transponders included in two or more optical communication devices.

In the above aspect, the first optical switch may outputs the optical signal input from the outside or the noise addition unit to one of the plurality of optical transponders or the second switch, and the second optical switch may output the optical signal input from one of the plurality of optical transponders or the first optical switch to the outside or the noise addition unit.

According to this aspect, outputting the optical signal from the first optical switch to the second optical switch makes it possible to transmit the optical signal to which noise is added by the noise addition unit to the optical transponder, without having added an independent optical switch other than the first optical switch and the second optical switch. Therefore, it is possible to easily measure the communication quality between the optical transponders included in each of two or more optical communication devices and prevent the number of parts from increasing.

In the above aspect, the first optical switch may include a plurality of first optical splitters configured to divide the optical signal input from outside, a fourth optical switch configured to output the optical signal input from the noise addition unit to a selected output destination, and a plurality of fifth optical switches each configured to output the optical signal input from one of the plurality of first optical splitters or the fourth optical switch to at least one of the plurality of optical transponders.

According to this aspect, distributing the optical signal input from the noise addition unit to the first optical switch from the fourth optical switch to the plurality of fifth optical switches makes it possible to reduce the number of times the optical signal passes through the optical splitter as compared to distributing the optical signal from the optical splitter to the plurality of fifth optical switches, thereby increasing the allowable amount of noise to be added by the noise addition unit. Therefore, an available margin of additional noise for measuring the communication quality between the optical transponders included in each of two or more optical communication devices is increased, thereby making it possible to more flexibly measure the communication quality.

In the above aspect, the second optical switch may include a plurality of sixth optical switches configured to output the optical signals input from the plurality of optical transponders to selected output destinations, a plurality of second optical splitters configured to divide the optical signals input from the plurality of sixth optical switches to outside, and a seventh optical switch configured to output the optical signals input from the plurality of sixth optical switches to the noise addition unit.

According to this aspect, transmitting the optical signal input from the optical transponder to the second optical switch from the seventh optical switch to the noise addition unit makes it possible to reduce the number of times the optical signal passes through the optical splitter as compared to transmitting the optical signal from the second optical splitter to the noise addition unit, thereby increasing the allowable amount of noise to be added by the noise addition unit. Therefore, an available margin of additional noise for measuring the communication quality between the optical transponders included in each of two or more optical communication devices is increased, thereby making it possible to more flexibly measure the communication quality.

In the above aspect, the optical communication device may further include a controller configured to control the plurality of optical transponders, the noise addition part, the first optical switch, and the second optical switch.

According to this aspect, controlling the noise addition unit and others by the controller makes it possible to autonomously measure the communication quality between the plurality of optical transponders included in the optical communication device.

An optical communication system according to an aspect of the present invention is an optical communication system including the optical communication device according to any one of the above aspects and a management device configured to manage the optical communication device. The optical communication device transmits the optical signal from one of two optical transponders of the plurality of optical transponders to the other via the noise addition unit to notify the management device of a measurement result of measuring communication quality.

According to this aspect, it is possible for the management device to collectively manage the measurement results obtained by measuring the communication qualities between the plurality of optical transponders included in the optical communication device, and in response to a request for checking the communication quality related to the same optical transponders from another optical communication device, it is possible to use the measurement results to check the communication quality more efficient.

In the above aspect, the optical communication system may include a first optical communication device and a second optical communication device that are each the optical communication device according to any one of the above aspects. The first optical communication device may transmit an optical signal from one of the plurality of optical transponders to the second optical communication device, and the second optical communication device may transmit the optical signal through the noise addition unit and receive the optical signal by one of the plurality of optical transponders. The first optical communication device and the second optical communication device may each notify the management device of the measurement result of measuring communication quality.

According to this aspect, it is possible to collectively manage the measurement result of measuring communication quality between the plurality of optical transponders included in each of the pair of the optical communication devices, and in response to a request for checking the communication quality related to the same optical transponders from the other optical communication device of the pair, it is possible to use the measurement results to check the communication quality more efficient. Further, adding noise in the optical communication device on the reception side makes it possible to simplify the processing of measuring communication quality as compared to adding noise in the optical communication device on the transmission side.

In the above aspect, the first optical communication device and the second optical communication device may update a combination of a plurality of optical transponders for which communication quality is to be measured at a predetermined cycle, and perform measurement of communication quality for each combination. The first optical communication device and the second optical communication device may notify the management device of each measurement result of measuring communication quality.

According to this aspect, the optical communication devices of the pair can each update the pair of the optical transponders pair for which communication quality is to be autonomously measured, and notify the management device of a collection of measurement results, thereby making it possible to reduce the processing load and communication load on the management device.

In the above aspect, the management device may include a storage unit configured to store a combination of types of optical transponders for which communication quality has already been measured among the plurality of optical transponders, together with a measurement result of communication quality related to the combination; a calculation unit configured to calculate a transmission characteristic of a path through which an optical signal is transmitted from the first communication device to the second optical communication device; and an estimation unit configured to estimate the communication quality based on the measurement result of communication quality stored in the storage unit and the transmission characteristic calculated by the calculation unit when a combination of an optical transponder of the first optical communication device and an optical transponder of the second optical communication device is the combination of types of optical transponders for which communication quality has already been measured.

According to this aspect, even when the combination of types of optical transponders for which communication quality has already been measured is connected via a network structure different from that when the communication quality is measured, it is possible to perform estimation of communication quality. Therefore, it is not necessary to measure the communication quality for each of the different network structures, it is possible to reduce the number of times of performing the processing of measuring the communication quality, and reduce the calculation load and communication load on the optical communication devices and the management device.

In the above aspect, the management device may further include an extraction unit configured to extract a combination of types of optical transponders for which communication quality has not been measured among the plurality of optical transponders, and the management device may cause one or both of the first optical communication device and the second optical communication device to perform measurement of communication quality on the combination of types of optical transponders extracted by the extraction unit to store the measurement result of communication quality in the storage unit.

According to this aspect, it is possible to reduce the number of combinations of types of optical transponders for which communication quality has not been measured, and increase the number of combinations of types of optical transponders for which communication quality can be estimated. As a result, it is possible to reduce the number of times of performing the processing of measuring the communication quality, and reduce the calculation load and communication load on the optical communication devices and the management device.

### Advantageous Effects of Invention

According to the present invention, it is possible to provide an optical communication device and an optical communication system capable of preventing the costs of equipment from increasing for an optical communication network constructed including devices provided by different vendors or devices of different generations.

### BRIEF DESCRIPTION OF DRAWINGS

FIG. 1 is a diagram illustrating an outline of an optical communication system according to an embodiment of the present invention.

FIG. 2 is a diagram illustrating a first example of a configuration of the optical communication device according to an embodiment of the present invention.

FIG. 3 is a diagram illustrating a second example of a configuration of the optical communication device according to an embodiment of the present invention.

FIG. 4 is a diagram illustrating a third example of a configuration of the optical communication device according to an embodiment of the present invention.

FIG. 5 is a diagram illustrating a fourth example of a configuration of the optical communication device according to an embodiment of the present invention.

FIG. 6 is a diagram illustrating a fifth example of a configuration of the optical communication device according to an embodiment of the present invention.

FIG. 7 is a diagram illustrating functional blocks of a management device according to an embodiment of the present invention.

FIG. 8 is a flowchart of first processing executed by the optical communication system according to an embodiment of the present invention.

FIG. 9 is a flowchart of second processing executed by the optical communication system according to an embodiment of the present invention.

FIG. 10 is a flowchart of third processing executed by the optical communication system according to an embodiment of the present invention.

FIG. 11 is a flowchart of fourth processing executed by the optical communication system according to an embodiment of the present invention.

FIG. 12 is a flowchart of fifth processing executed by the optical communication system according to an embodiment of the present invention.

### DESCRIPTION OF EMBODIMENTS

Embodiments of the present invention will be described with reference to the accompanying drawings. It is to be noted that, in each figure, identical reference numerals indicate those having identical or similar configurations.

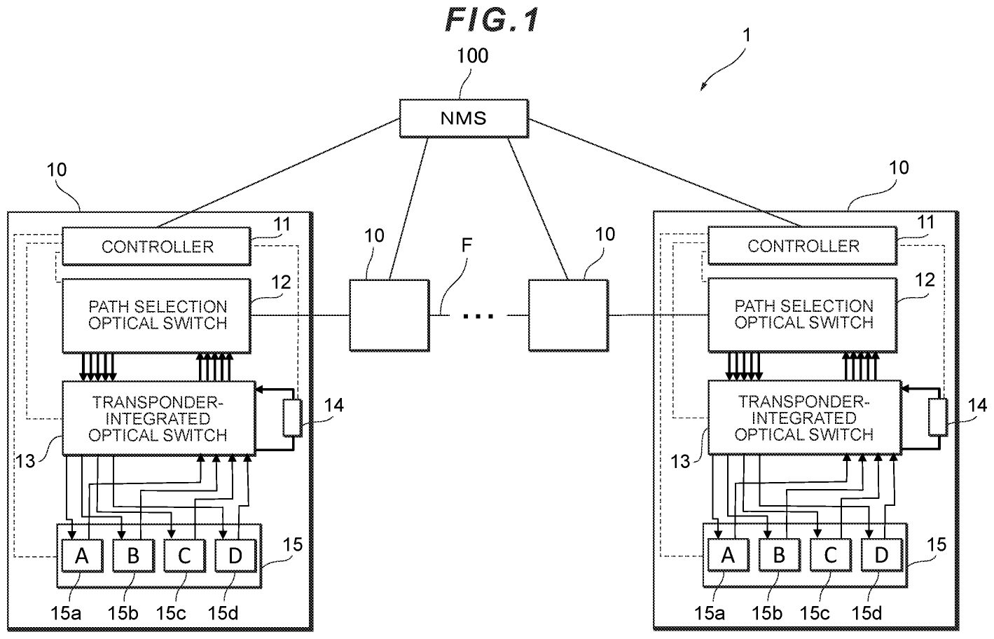

FIG. 1 is a diagram illustrating an outline of an optical communication system 1 according to an embodiment of the present invention. The optical communication system 1 includes a plurality of optical communication devices 10 and a management device 100 that manages the optical communication devices 10. In the present example, the plurality of optical communication devices 10 are connected by an optical fiber F to transmit and receive optical signals. The optical communication device 10 includes a controller 11, a path selection optical switch 12, a transponder-integrated optical switch 13, a noise addition unit 14, and a transponder bank 15. The controller 11 controls the path selection optical switch 12, the transponder-integrated optical switch 13, the noise addition unit 14, and the transponder bank 15. The path selection optical switch 12 outputs an optical signal input from the optical fiber F to a predetermined port of the transponder-integrated optical switch 13 and outputs the optical signal input from the transponder-integrated optical switch 13 to the optical fiber F. The path selection optical switch 12 may be constructed from, for example, a wavelength selection optical switch, an optical splitter, an optical switch, or the like. The noise addition unit 14 adds noise that degrades signal quality to the input optical signal and outputs the resulting optical signal. Here, the addition of noise is any single one or combination of light intensity loss addition, ASE (Amplified Spontaneous Emission) addition, chromatic dispersion addition, polarization dispersion addition, PDL (Polarization Dependent Loss) addition, band narrowing, and the like. The transponder bank 15 includes a first optical transponder 15a, a second optical transponder 15b, a third optical transponder 15c, and a fourth optical transponder 15d. The transponder bank 15 of the present example includes the four optical transponders. However, the transponder bank 15 may include any number of optical transponders. The optical transponder performs mutual conversion between an optical signal and an electrical signal. It is to be noted that FIG. 1 illustrates optical signals input to and output from the optical transponders but does not illustrate electrical signals to be input and output. However, the optical transponder may have a client-side port for connecting to an Ether switch or the like.

The management device 100 transmits a signal for controlling the transmission path for optical signals to the controller 11 of the optical communication device 10 or receives a measurement result of communication quality from the optical communication device 10. The management device 100 of the present example is represented as NMS (Network Management System). It is to be noted that FIG. 1 illustrates an example in which the plurality of optical communication devices 10 are connected in series by the optical fiber F and each connected to the management device 100. However, the configuration of the optical communication system 1 is not limited to this. A network constituted from the plurality of optical communication devices 10 may have any structure, and the management device 100 does not necessarily have to control all the optical communication devices 10.

As an example in which an optical communication network is configured including devices provided by different vendors or devices of different generations is, for example, a configuration in which optical transponders provided by different vendors or optical transponders of different generations are included in the optical communication device 10. In such a configuration, optical signals are transmitted and received between the plurality of optical transponders included in the optical communication device 10, and the communication quality is measured to check whether predetermined communication quality is satisfied. It is to be noted that the communication quality may be measured by using a bit error rate measurement function that the optical transponder has while the noise addition unit 14 changes the OSNR (Optical Signal to Noise Ratio), or by using an external measurement device.

Further, as another example in which an optical communication network is configured including devices provided by different vendors or devices of different generations is, for example, a configuration in which the vendors and generations of the plurality of optical transponders included in each optical communication device 10 are unified but the vendors and generations of the optical transponders included are different when the plurality of optical communication devices 10 are compared. In such a configuration, optical signals are transmitted and received between the plurality of optical communication devices 10, and the communication quality is measured to check whether predetermined communication quality is satisfied. Also in this case, the communication quality may be measured by using a bit error rate measurement function that the optical transponder has while the noise addition unit 14 changes the OSNR (Optical Signal to Noise Ratio), or by using an external measurement device.

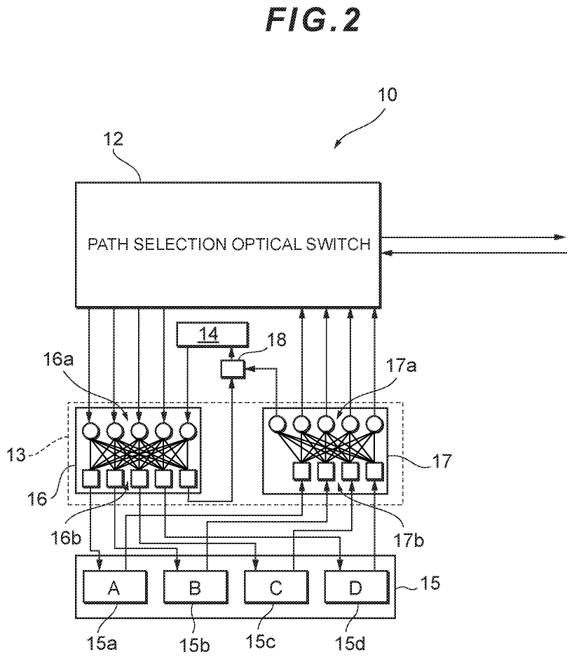

FIG. 2 is a diagram illustrating a first example of a configuration of the optical communication device 10 according to an embodiment of the present invention. FIG. 2 does not illustrate the controller 11 included in the optical communication device 10. The first to fifth examples of the configuration of the optical communication device 10 described below are different in the internal configuration of the transponder-integrated optical switch 13 and the presence/absence of the third optical switch 18, but the configurations of the path selection optical switch 12, the noise addition unit 14, and the transponder bank 15 are in common with the examples.

The optical communication device 10 of the present example includes, as an internal configuration of the transponder-integrated optical switch 13, a first optical switch 16 that outputs an optical signal input from the outside or the noise addition unit 14 to at least one of the plurality of optical transponders, and a second optical switch 17 that directly or indirectly outputs an optical signal input from at least one of the plurality of optical transponders to the outside or the noise addition unit 14. More specifically, the first optical switch 16 outputs an optical signal input from the outside or the noise addition unit 14 to one of the plurality of optical transponders or a third optical switch 18, and the second optical switch 17 outputs an optical signal input from one of the plurality of optical transponders to the outside or the third optical switch 18. Here, the optical signal input from the outside is an optical signal input from the optical fiber F (see FIG. 1) externally connected via the path selection optical switch 12. Further, “directly or indirectly outputting an optical signal to the outside” means outputting the optical signal to the optical fiber F externally connected via the path selection optical switch 12.

In the present example, the first optical switch 16 includes a plurality of first optical splitters 16a that divide the optical signal input from the outside or the noise addition unit 14, and a plurality of fifth optical switches 16b that output the optical signals input from the plurality of first optical splitters 16a to at least one of the plurality of optical transponders. The plurality of first optical splitters 16a are indicated by circles in FIG. 2, and divide optical signals input from the outside, that is, optical signals input from the optical fiber F externally connected via the path selection optical switch 12 and output them to the plurality of fifth optical switches 16b. The plurality of fifth optical switches 16b are indicated by squares in FIG. 2, and each output the input optical signal to the corresponding optical transponder or the third optical switch 18. Here, the plurality of fifth optical switches 16b each output or does not output the optical signal to the optical transponder or the third optical switch 18 depending on the control signal received from the controller 11. In this way, the optical signal input from the externally connected optical fiber F is selectively output to the first optical transponder 15a, the second optical transponder 15b, the third optical transponder 15c, the fourth optical transponder 15d, or the third optical switch 18.

In the present example, the second optical switch 17 includes a plurality of sixth optical switches 17b that each output the optical signal input from the plurality of optical transponders to a selected output destination, and a plurality of second optical splitters 17a that each output the optical signal input from the plurality of sixth optical switches 17b to one of the outside, the noise addition unit 14, and the third optical switch 18. The plurality of sixth optical switches 17b are indicated by squares in FIG. 2, and output or does not the output optical signal input from one of the first optical transponder 15a, the second optical transponder 15b, the third optical transponder 15c, and the fourth optical transponder 15d to one of the plurality of second optical splitters 17a depending on the control signal received from the controller 11. The plurality of second optical splitters 17a are indicated by circles in FIG. 2, and each output the optical signal input from the plurality of sixth optical switches 17b to one of the path selection optical switch 12, the noise addition unit 14, and the third optical switch 18.

As an example, a case where communication quality is measured between the first optical transponder 15a and the second optical transponder 15b included in the optical communication device 10 will be described. The optical signal output from the first optical transponder 15a is input to one of the plurality of sixth optical switches 17b (the second optical switch from the left illustrated in FIG. 2), transmitted to one of the plurality of second optical splitters 17a (the leftmost optical splitter illustrated in FIG. 2), and input to the third optical switch 18 from the optical splitter. The third optical switch 18 outputs the input optical signal to the noise addition unit 14. The noise addition unit 14 adds noise that degrades signal quality to the input optical signal, and outputs the resulting optical signal to one of the plurality of first optical splitters 16a (the rightmost optical splitter illustrated in FIG. 2). The optical signal to which the noise is added is transmitted from the optical splitter to the plurality of fifth optical switches 16b, and output from one of the plurality of fifth optical switches 16b (the second optical switch from the left illustrated in FIG. 2) to the second optical transponder 15b. The controller 11 of the optical communication device 10 compares the optical signal transmitted by the first optical transponder 15a, the noise added by the noise addition unit 14, and the optical signal received by the second optical transponder 15b, to measure how much margin is secured with respect to a predetermined criterion relates to communication quality and to measure the communication quality between the first optical transponder 15a and the second optical transponder 15b. Here, the case where communication quality is measured between the first optical transponder 15a and the second optical transponder 15b has been described. Similarly, communication quality can be measured between any optical transponders. Further, communication qualities can be measured simultaneously for a plurality of pairs of optical transponders, and an optical signal transmitted from one optical transponder can be received by a plurality of optical transponders to measure one-to-many communication qualities.

According to the optical communication device 10 according to the present embodiment, the noise addition unit 14 adding noise to the optical signal transmitted between the plurality of optical transponders on purpose makes it possible to measure the communication quality on demand for an optical communication network constructed including devices provided by different vendors or devices of different generations. Therefore, it is possible to specify a combination of devices having communication quality of a certain level or more, and to introduce devices having various performances, and thus it is possible to prevent the costs of equipment from increasing.

The controller 11 controls the plurality of optical transponders, the noise addition unit 14, the first optical switch 16, and the second optical switch 17. The optical communication device 10 includes the controller 11, and thus can autonomously measure communication qualities between the plurality of optical transponders.

Next, as another example, a case where communication quality is measured between an optical transponder included in another optical communication device 10 and the first optical transponder 15a included in the optical communication device 10 will be described. The optical signal output from the optical transponder included in the other optical communication device 10 is transmitted via the optical fiber F (see FIG. 1), and input to one of the plurality of first optical splitters 16a of the first optical switch 16 by the path selection optical switch 12. When receiving the inputs, the first optical splitter 16a outputs the optical signals to the plurality of fifth optical switches 16b. One of the plurality of fifth optical switches 16b (the rightmost optical splitter illustrated in FIG. 2) outputs the input optical signal to the third optical switch 18, and the third optical switch 18 outputs the input optical signal to the noise addition unit 14. The noise addition unit 14 adds noise that degrades signal quality to the input optical signal, and outputs the resulting optical signal to one of the plurality of first optical splitters 16a (the rightmost optical splitter illustrated in FIG. 2). The optical signal to which the noise is added is transmitted from the optical splitter to the plurality of fifth optical switches 16b, and output from one of the plurality of fifth optical switches 16b (the leftmost optical switch illustrated in FIG. 2) to the first optical transponder 15a. The controller 11 of the optical communication device 10 compares the optical signal transmitted by the optical transponder included in the other optical communication device 10, the noise added by the noise addition unit 14, and the optical signal received by the first optical transponder 15a, to measure how much margin is secured with respect to a predetermined criterion relates to communication quality and to measure the communication quality between the optical transponder included in the other optical communication device 10 and the first optical transponder 15a. Here, the case where communication quality is measured between the optical transponder included in the other optical communication device 10 and the first optical transponder 15a has been described. Similarly, communication quality can be measured between an optical transponder included in the other optical communication device 10 and any optical transponder. Further, communication qualities can be measured simultaneously for a plurality of pairs of optical transponders, and an optical signal transmitted from one optical transponder can be received by a plurality of optical transponders to measure one-to-many communication qualities.

In the optical communication device 10 according to the present embodiment, including the third optical switch 18 to which the optical signal is input from the first optical switch 16 makes it possible to add noise to the optical signal input from the outside and transmit the resulting optical signal to the optical transponder. Therefore, it is possible to easily measure the communication quality between optical transponders included in two or more optical communication devices 10.

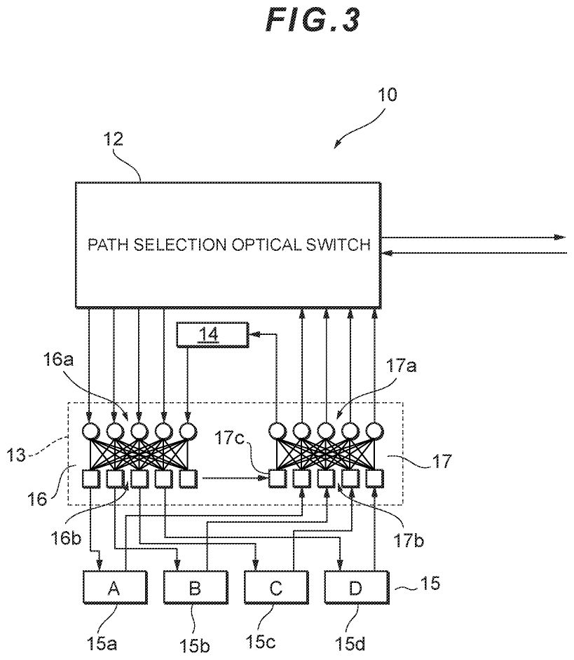

FIG. 3 is a diagram illustrating a second example of a configuration of the optical communication device 10 according to an embodiment of the present invention. The optical communication device 10 of the present example is different from the first example in that the third optical switch 18 is not included and the internal configuration of the transponder-integrated optical switch 13 is different. The first optical switch 16 of the present example outputs an optical signal input from the outside or the noise addition unit 14 to one of the plurality of optical transponders or the second optical switch 17, and the second optical switch 17 outputs an optical signal input from one of the plurality of optical transponders or the first optical switch 16 to the outside or the noise addition unit 14.

In the present example, the first optical switch 16 includes the plurality of first optical splitters 16a that divide the optical signal input from the outside or the noise addition unit 14, and the plurality of fifth optical switches 16b that output the optical signals input from the plurality of first optical splitters 16a to one of the plurality of optical transponders or the second optical switch 17. The plurality of first optical splitters 16a are indicated by circles in FIG. 3, and divide optical signals input from the outside, that is, optical signals input from the optical fiber F externally connected via the path selection optical switch 12 and output them to the plurality of fifth optical switches 16b. The plurality of fifth optical switches 16b are indicated by squares in FIG. 3, and each output the input optical signal to the corresponding optical transponder or the second optical switch 17. Here, the plurality of fifth optical switches 16b each output or does not output the optical signal to the optical transponder or the second optical switch 17 depending on the control signal received from the controller 11. In this way, the optical signal input from the externally connected optical fiber F is selectively output to the first optical transponder 15a, the second optical transponder 15b, the third optical transponder 15c, the fourth optical transponder 15d, or the second optical switch 17.

In the present example, the second optical switch 17 includes the plurality of sixth optical switches 17b and an eighth optical switch 17c that each output the optical signal input from one of the plurality of optical transponders or the first optical switch 16 to a selected output destination, and the plurality of second optical splitters 17a that each output the optical signal input from the plurality of sixth optical switches 17b and the eighth optical switch 17c to the outside or the noise addition unit 14. The plurality of sixth optical switches 17b and the eighth optical switch 17c are indicated by squares in FIG. 3, and output or does not the output optical signal input from one of the first optical transponder 15a, the second optical transponder 15b, the third optical transponder 15c, the fourth optical transponder 15d, and the first optical switch 16 to one of the plurality of second optical splitters 17a depending on the control signal received from the controller 11. The plurality of second optical splitters 17a are indicated by circles in FIG. 3, and each output the optical signal input from the plurality of sixth optical switches 17b and the eighth optical switch 17c to one of the path selection optical switch 12 and the noise addition unit 14.

As an example, a case where communication quality is measured between the first optical transponder 15a and the second optical transponder 15b included in the optical communication device 10 will be described. The optical signal output from the first optical transponder 15a is input to one of the plurality of sixth optical switches 17b (the second optical switch from the left illustrated in FIG. 3), transmitted to one of the plurality of second optical splitters 17a (the leftmost optical splitter illustrated in FIG. 3), and input to the noise addition unit 14 from the optical splitter. The noise addition unit 14 adds noise that degrades signal quality to the input optical signal, and outputs the resulting optical signal to one of the plurality of first optical splitters 16a (the rightmost optical splitter illustrated in FIG. 3). The optical signal to which the noise is added is transmitted from the optical splitter to the plurality of fifth optical switches 16b, and output from one of the plurality of fifth optical switches 16b (the second optical switch from the left illustrated in FIG. 3) to the second optical transponder 15b. The controller 11 of the optical communication device 10 compares the optical signal transmitted by the first optical transponder 15a, the noise added by the noise addition unit 14, and the optical signal received by the second optical transponder 15b, to measure how much margin is secured with respect to a predetermined criterion relates to communication quality and to measure the communication quality between the first optical transponder 15a and the second optical transponder 15b.

Next, as another example, a case where communication quality is measured between an optical transponder included in another optical communication device 10 and the first optical transponder 15a included in the optical communication device 10 will be described. The optical signal output from the optical transponder included in the other optical communication device 10 is transmitted via the optical fiber F (see FIG. 1), and input to one of the plurality of first optical splitters 16a of the first optical switch 16 by the path selection optical switch 12. When receiving the inputs, the first optical splitter 16a outputs the optical signals to the plurality of fifth optical switches 16b. One of the plurality of fifth optical switch 16b (the rightmost optical splitter illustrated in FIG. 3) outputs the input signal to the eighth optical switch 17c included in the second optical switch 17, and the eighth optical switch 17c outputs the input signal to one of the second optical splitters 17a (the leftmost optical splitter illustrated in FIG. 3). The optical signal is input to the noise addition unit 14 from the optical splitter, and the noise addition unit 14 adds noise that degrades signal quality to the input optical signal and outputs the resulting optical signal to one of the plurality of first optical splitters 16a (the rightmost optical splitter illustrated in FIG. 3). The optical signal to which the noise is added is transmitted from the optical splitter to the plurality of fifth optical switches 16b, and output from one of the plurality of fifth optical switches 16b (the leftmost optical switch illustrated in FIG. 3) to the first optical transponder 15a. The controller 11 of the optical communication device 10 compares the optical signal transmitted by the optical transponder included in the other optical communication device 10, the noise added by the noise addition unit 14, and the optical signal received by the first optical transponder 15a, to measure how much margin is secured with respect to a predetermined criterion relates to communication quality and to measure the communication quality between the optical transponder included in the other optical communication device 10 and the first optical transponder 15a. Here, the case where communication quality is measured between the optical transponder included in the other optical communication device 10 and the first optical transponder 15a has been described. Similarly, communication quality can be measured between an optical transponder included in the other optical communication device 10 and any optical transponder. Further, communication qualities can be measured simultaneously for a plurality of pairs of optical transponders, and an optical signal transmitted from one optical transponder can be received by a plurality of optical transponders to measure one-to-many communication qualities.

In the optical communication device 10 according to the present embodiment, outputting the optical signal from the first optical switch 16 to the second optical switch 17 makes it possible to transmit the optical signal to which noise is added by the noise addition unit to the optical transponder, without having added an independent optical switch other than the first optical switch 16 and the second optical switch 17. Therefore, it is possible to easily measure the communication quality between the optical transponders included in each of two or more optical communication devices and prevent the number of parts from increasing.

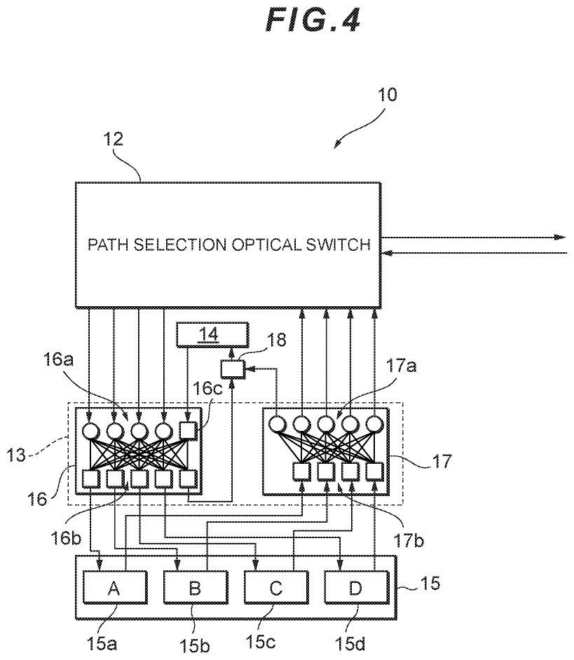

FIG. 4 is a diagram illustrating a third example of a configuration of the optical communication device 10 according to an embodiment of the present invention. The optical communication device 10 of the present example is different from the first example in that the internal configuration of the transponder-integrated optical switch 13 is different. The first optical switch 16 of the present example includes a fourth optical switch 16c that outputs the optical signal input from the noise addition unit 14 to a selected output destination.

In the present example, the first optical switch 16 includes the plurality of first optical splitters 16a that divide the optical signal input from the outside or the noise addition unit 14, the fourth optical switch 16c that outputs the optical signal input from the noise addition unit 14 to a selected output destination, and the plurality of fifth optical switches 16b that each output the optical signal input from one of the plurality of first optical splitters 16a or the fourth optical switch 16c to one of the plurality of optical transponders or the second optical switch 17. The plurality of first optical splitters 16a are indicated by circles in FIG. 3, and divide optical signals input from the outside, that is, optical signals input from the optical fiber F externally connected via the path selection optical switch 12 and output them to the plurality of fifth optical switches 16b. The fourth optical switch 16c is indicated by a square in FIG. 4. The plurality of fifth optical switches 16b are indicated by squares in FIG. 3, and each output the input optical signal to the corresponding optical transponder or the second optical switch 17. Here, the plurality of fifth optical switches 16b each output or does not output the optical signal to the optical transponder or the third optical switch 18 depending on the control signal received from the controller 11. In this way, the optical signal input from the externally connected optical fiber F (see FIG. 1) is selectively output to the first optical transponder 15a, the second optical transponder 15b, the third optical transponder 15c, the fourth optical transponder 15d, or the third optical switch 18.

In the present example, the second optical switch 17 includes a plurality of sixth optical switches 17b that each output the optical signal input from one of the plurality of optical transponders or the first optical switch 16 to a selected output destination, and a plurality of second optical splitters 17a that each output the optical signal input from the plurality of sixth optical switches 17b to the outside or the third optical switch 18. The plurality of sixth optical switches 17b are indicated by squares in FIG. 4, and output or does not the output optical signal input from one of the first optical transponder 15a, the second optical transponder 15b, the third optical transponder 15c, and the fourth optical transponder 15d to one of the plurality of second optical splitters 17a depending on the control signal received from the controller 11. The plurality of second optical splitters 17a are indicated by circles in FIG. 4, and each output the optical signal input from the plurality of sixth optical switches 17b and the eighth optical switch 17c to the path selection optical switch 12 or the third optical switch 18.

As an example, a case where communication quality is measured between the first optical transponder 15a and the second optical transponder 15b included in the optical communication device 10 will be described. The optical signal output from the first optical transponder 15a is input to one of the plurality of sixth optical switches 17b (the second optical switch from the left illustrated in FIG. 4), transmitted to one of the plurality of second optical splitters 17a (the leftmost optical splitter illustrated in FIG. 4), and input to the third optical switch 18 from the optical splitter. The third optical switch 18 outputs the input optical signal to the noise addition unit 14. The noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the second optical switch from the left illustrated in FIG. 4), and output from the fifth optical switch 16b to the second optical transponder 15b. The controller 11 of the optical communication device 10 compares the optical signal transmitted by the first optical transponder 15a, the noise added by the noise addition unit 14, and the optical signal received by the second optical transponder 15b, to measure how much margin is secured with respect to a predetermined criterion relates to communication quality and to measure the communication quality between the first optical transponder 15a and the second optical transponder 15b. Here, the case where communication quality is measured between the first optical transponder 15a and the second optical transponder 15b has been described. Similarly, communication quality can be measured between any optical transponders. Further, communication qualities can be measured simultaneously for a plurality of pairs of optical transponders, and an optical signal transmitted from one optical transponder can be received by a plurality of optical transponders to measure one-to-many communication qualities.

Next, as another example, a case where communication quality is measured between an optical transponder included in another optical communication device 10 and the first optical transponder 15a included in the optical communication device 10 will be described. The optical signal output from the optical transponder included in the other optical communication device 10 is transmitted via the optical fiber F (see FIG. 1), and input to one of the plurality of first optical splitters 16a of the first optical switch 16 by the path selection optical switch 12. When receiving the inputs, the first optical splitter 16a outputs the optical signals to the plurality of fifth optical switches 16b. One of the plurality of fifth optical switches 16b (the rightmost optical splitter illustrated in FIG. 4) outputs the input optical signal to the third optical switch 18, and the third optical switch 18 outputs the input optical signal to the noise addition unit 14. The noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the leftmost optical switch illustrated in FIG. 4), and output from the fifth optical switch 16b to the first optical transponder 15a. The controller 11 of the optical communication device 10 compares the optical signal transmitted by the optical transponder included in the other optical communication device 10, the noise added by the noise addition unit 14, and the optical signal received by the first optical transponder 15a, to measure how much margin is secured with respect to a predetermined criterion relates to communication quality and to measure the communication quality between the optical transponder included in the other optical communication device 10 and the first optical transponder 15a. Here, the case where communication quality is measured between the optical transponder included in the other optical communication device 10 and the first optical transponder 15a has been described. Similarly, communication quality can be measured between an optical transponder included in the other optical communication device 10 and any optical transponder. Further, communication qualities can be measured simultaneously for a plurality of pairs of optical transponders, and an optical signal transmitted from one optical transponder can be received by a plurality of optical transponders to measure one-to-many communication qualities.

In the optical communication device 10 according to the present embodiment, distributing the optical signal input from the noise addition unit 14 to the first optical switch 16 from the fourth optical switch 16c to the plurality of fifth optical switches 16b makes it possible to reduce the number of times the optical signal passes through the optical splitter as compared to distributing the optical signal from the optical splitter to the plurality of fifth optical switches 16b, thereby increasing the allowable amount of noise to be added by the noise addition unit 14. Therefore, an available margin of additional noise for measuring the communication quality between the optical transponders included in each of two or more optical communication devices 10 is increased, thereby making it possible to more flexibly measure the communication quality.

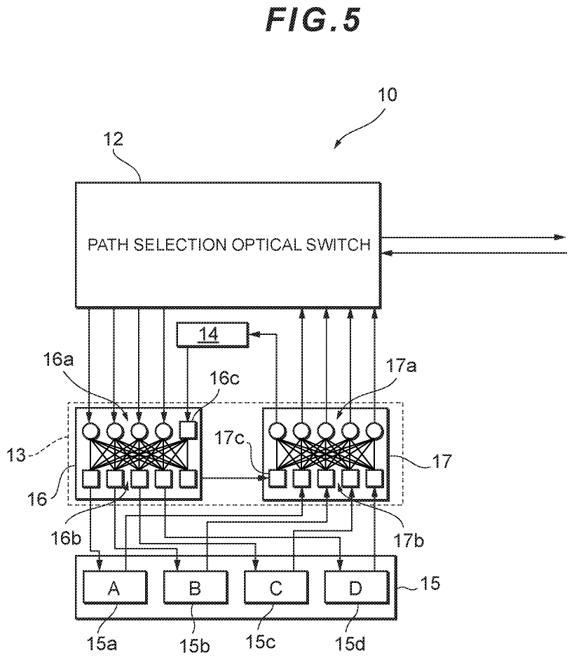

FIG. 5 is a diagram illustrating a fourth example of a configuration of the optical communication device 10 according to an embodiment of the present invention. The optical communication device 10 of the present example is different from the first example in that the third optical switch 18 is not included and the internal configuration of the transponder-integrated optical switch 13 is different. The first optical switch 16 of the present example outputs an optical signal input from the outside or the noise addition unit 14 to one of the plurality of optical transponders or the second optical switch 17, and the second optical switch 17 outputs an optical signal input from one of the plurality of optical transponders or the first optical switch 16 to the outside or the noise addition unit 14. Further, the first optical switch 16 of the present example includes a fourth optical switch 16c that outputs the optical signal input from the noise addition unit 14 to a selected output destination.

In the present example, the first optical switch 16 includes the plurality of first optical splitters 16a that divide the optical signal input from the outside, the fourth optical switch 16c that outputs the optical signal input from the noise addition unit 14 to a selected output destination, and the plurality of fifth optical switches 16b that each output the optical signal input from one of the plurality of first optical splitters 16a or the fourth optical switch 16c to one of the plurality of optical transponders or the second optical switch 17. The plurality of first optical splitters 16a are indicated by circles in FIG. 3, and divide optical signals input from the outside, that is, optical signals input from the optical fiber F externally connected via the path selection optical switch 12 and output them to the plurality of fifth optical switches 16b. The fourth optical switch 16c is indicated by a square in FIG. 5. The plurality of fifth optical switches 16b are indicated by squares in FIG. 5, and each output the input optical signal to the corresponding optical transponder or the second optical switch 17. Here, the plurality of fifth optical switches 16b each output or does not output the optical signal to the optical transponder or the second optical switch 17 depending on the control signal received from the controller 11. In this way, the optical signal input from the externally connected optical fiber F is selectively output to the first optical transponder 15a, the second optical transponder 15b, the third optical transponder 15c, the fourth optical transponder 15d, or the second optical switch 17.

In the present example, the second optical switch 17 includes the plurality of sixth optical switches 17b and an eighth optical switch 17c that each output the optical signal input from one of the plurality of optical transponders or the first optical switch 16 to a selected output destination, and the plurality of second optical splitters 17a that each output the optical signal input from the plurality of sixth optical switches 17b and the eighth optical switch 17c to the outside or the noise addition unit 14. The plurality of sixth optical switches 17b and the eighth optical switch 17c are indicated by squares in FIG. 5, and output or does not the output optical signal input from one of the first optical transponder 15a, the second optical transponder 15b, the third optical transponder 15c, the fourth optical transponder 15d, and the first optical switch 16 to one of the plurality of second optical splitters 17a depending on the control signal received from the controller 11. The plurality of second optical splitters 17a are indicated by circles in FIG. 3, and each output the optical signal input from the plurality of sixth optical switches 17b and the eighth optical switch 17c to one of the path selection optical switch 12 and the noise addition unit 14.

As an example, a case where communication quality is measured between the first optical transponder 15a and the second optical transponder 15b included in the optical communication device 10 will be described. The optical signal output from the first optical transponder 15a is input to one of the plurality of sixth optical switches 17b (the second optical switch from the left illustrated in FIG. 5), transmitted to one of the plurality of second optical splitters 17a (the leftmost optical splitter illustrated in FIG. 5), and input to the noise addition unit 14 from the optical splitter. The noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the second optical switch from the left illustrated in FIG. 5), and output from the fifth optical switch 16b to the second optical transponder 15b. The controller 11 of the optical communication device 10 compares the optical signal transmitted by the first optical transponder 15a, the noise added by the noise addition unit 14, and the optical signal received by the second optical transponder 15b, to measure how much margin is secured with respect to a predetermined criterion relates to communication quality and to measure the communication quality between the first optical transponder 15a and the second optical transponder 15b.

Next, as another example, a case where communication quality is measured between an optical transponder included in another optical communication device 10 and the first optical transponder 15a included in the optical communication device 10 will be described. The optical signal output from the optical transponder included in the other optical communication device 10 is transmitted via the optical fiber F (see FIG. 1), and input to one of the plurality of first optical splitters 16a of the first optical switch 16 by the path selection optical switch 12. When receiving the inputs, the first optical splitter 16a outputs the optical signals to the plurality of fifth optical switches 16b. One of the plurality of fifth optical switch 16b (the rightmost optical splitter illustrated in FIG. 5) outputs the input signal to the eighth optical switch 17c included in the second optical switch 17, and the eighth optical switch 17c outputs the input signal to one of the second optical splitters 17a (the leftmost optical splitter illustrated in FIG. 5). The optical signal is input to the noise addition unit 14 from the optical splitter, and the noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the leftmost optical switch illustrated in FIG. 5), and output from the fifth optical switch 16b to the first optical transponder 15a. The controller 11 of the optical communication device 10 compares the optical signal transmitted by the optical transponder included in the other optical communication device 10, the noise added by the noise addition unit 14, and the optical signal received by the first optical transponder 15a, to measure how much margin is secured with respect to a predetermined criterion relates to communication quality and to measure the communication quality between the optical transponder included in the other optical communication device 10 and the first optical transponder 15a. Here, the case where communication quality is measured between the optical transponder included in the other optical communication device 10 and the first optical transponder 15a has been described. Similarly, communication quality can be measured between an optical transponder included in the other optical communication device 10 and any optical transponder. Further, communication qualities can be measured simultaneously for a plurality of pairs of optical transponders, and an optical signal transmitted from one optical transponder can be received by a plurality of optical transponders to measure one-to-many communication qualities.

In the optical communication device 10 according to the present embodiment, outputting the optical signal from the first optical switch 16 to the second optical switch 17 makes it possible to transmit the optical signal to which noise is added by the noise addition unit 14 to the optical transponder, without having added an independent optical switch other than the first optical switch 16 and the second optical switch 17. Further, distributing the optical signal input from the noise addition unit 14 to the first optical switch 16 from the fourth optical switch 16c to the plurality of fifth optical switches 16b makes it possible to reduce the number of times the optical signal passes through the optical splitter as compared to distributing the optical signal from the optical splitter to the plurality of fifth optical switches 16b, thereby increasing the allowable amount of noise to be added by the noise addition unit 14. Therefore, an available margin of additional noise for measuring the communication quality between the optical transponders included in each of two or more optical communication devices is increased, thereby making it possible to more flexibly measure the communication quality.

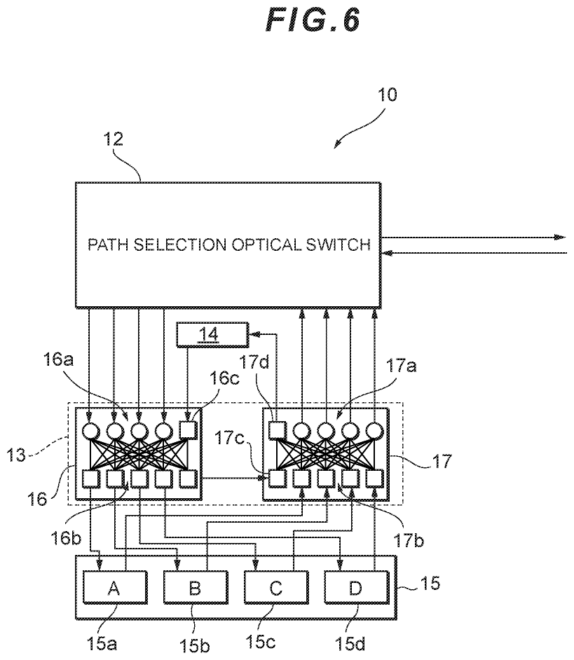

FIG. 6 is a diagram illustrating a fifth example of the configuration of the optical communication device 10 according to an embodiment of the present invention. The optical communication device 10 of the present example is different from the first example in that the third optical switch 18 is not included and the internal configuration of the transponder-integrated optical switch 13 is different. The first optical switch 16 of the present example outputs an optical signal input from the outside or the noise addition unit 14 to one of the plurality of optical transponders or the second optical switch 17, and the second optical switch 17 outputs an optical signal input from one of the plurality of optical transponders or the first optical switch 16 to the outside or the noise addition unit 14. Further, the first optical switch 16 of the present example includes a fourth optical switch 16c that outputs the optical signal input from the noise addition unit 14 to a selected output destination. Further, the second optical switch 17 of the present example includes a seventh optical switch 17d that outputs the optical signals input from the plurality of sixth optical switches 17b to the noise addition unit 14.

In the present example, the first optical switch 16 includes the plurality of first optical splitters 16a that divide the optical signal input from the outside, the fourth optical switch 16c that outputs the optical signal input from the noise addition unit 14 to a selected output destination, and the plurality of fifth optical switches 16b that each output the optical signal input from one of the plurality of first optical splitters 16a or the fourth optical switch 16c to one of the plurality of optical transponders or the second optical switch 17. The plurality of first optical splitters 16a are indicated by circles in FIG. 6, and divide optical signals input from the outside, that is, optical signals input from the optical fiber F (see FIG. 1) externally connected via the path selection optical switch 12 and output them to the plurality of fifth optical switches 16b. The fourth optical switch 16c is indicated by a square in FIG. 6. The plurality of fifth optical switches 16b are indicated by squares in FIG. 6, and each output the input optical signal to the corresponding optical transponder or the second optical switch 17. Here, the plurality of fifth optical switches 16b each output or does not output the optical signal to the optical transponder or the second optical switch 17 depending on the control signal received from the controller 11. In this way, the optical signal input from the externally connected optical fiber F is selectively output to the first optical transponder 15a, the second optical transponder 15b, the third optical transponder 15c, the fourth optical transponder 15d, or the second optical switch 17.

In the present example, the second optical switch 17 includes the plurality of sixth optical switches 17b and an eighth optical switch 17c that each output the optical signal input from one of the plurality of optical transponders or the first optical switch 16 to a selected output destination, the plurality of second optical splitters 17a that each output the optical signal input from the plurality of sixth optical switches 17b and the eighth optical switch 17c to the outside, and the seventh optical switch 17d that outputs the optical signals input from the plurality of sixth optical switches 17b and the eighth optical switch 17c to the noise addition unit 14. The plurality of sixth optical switches 17b and the eighth optical switch 17c are indicated by squares in FIG. 6, and output or does not the output optical signal input from one of the first optical transponder 15a, the second optical transponder 15b, the third optical transponder 15c, the fourth optical transponder 15d, and the first optical switch 16 to one of the plurality of second optical splitters 17a or the seventh optical switch 17d depending on the control signal received from the controller 11. The plurality of second optical splitters 17a are indicated by circles in FIG. 6, and each output the optical signal input from the plurality of sixth optical switches 17b and the eighth optical switch 17c to the path selection optical switch 12. The seventh optical switch 17d is indicated by a square in FIG. 6, and outputs the optical signals input from the plurality of sixth optical switches 17b and the eighth optical switch 17c to the noise addition unit 14.

As an example, a case where communication quality is measured between the first optical transponder 15a and the second optical transponder 15b included in the optical communication device 10 will be described. The optical signal output from the first optical transponder 15a is input to one of the plurality of sixth optical switches 17b (the second optical switch from the left illustrated in FIG. 6), transmitted to the seventh optical switch 17d, and output to the noise addition unit 14 from the seventh optical switch 17d. The noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the second optical switch from the left illustrated in FIG. 6), and output from the fifth optical switch 16b to the second optical transponder 15b. The controller 11 of the optical communication device 10 compares the optical signal transmitted by the first optical transponder 15a, the noise added by the noise addition unit 14, and the optical signal received by the second optical transponder 15b, to measure how much margin is secured with respect to a predetermined criterion relates to communication quality and to measure the communication quality between the first optical transponder 15a and the second optical transponder 15b.

Next, as another example, a case where communication quality is measured between an optical transponder included in another optical communication device 10 and the first optical transponder 15a included in the optical communication device 10 will be described. The optical signal output from the optical transponder included in the other optical communication device 10 is transmitted via the optical fiber F (see FIG. 1), and input to one of the plurality of first optical splitters 16a of the first optical switch 16 by the path selection optical switch 12. When receiving the inputs, the first optical splitter 16a outputs the optical signals to the plurality of fifth optical switches 16b. One of the plurality of fifth optical switches 16b (the rightmost optical splitter illustrated in FIG. 6) outputs the input optical signal to the eighth optical switch 17c included in the second optical switch 17, and the eighth optical switch 17c outputs the input optical signal to the seventh optical switch 17d. The optical signal is input to the noise addition unit 14 from the seventh optical switch 17d, and the noise addition unit 14 adds noise that degrades signal quality to the input optical signal and outputs the resulting signal to the fourth optical switch 16c. The optical signal to which the noise is added is transmitted from the fourth optical switch 16c to one of the plurality of fifth optical switches 16b (the leftmost optical switch illustrated in FIG. 6), and output from the fifth optical switch 16b to the first optical transponder 15a. The controller 11 of the optical communication device 10 compares the optical signal transmitted by the optical transponder included in the other optical communication device 10, the noise added by the noise addition unit 14, and the optical signal received by the first optical transponder 15a, to measure how much margin is secured with respect to a predetermined criterion relates to communication quality and to measure the communication quality between the optical transponder included in the other optical communication device 10 and the first optical transponder 15a. Here, the case where communication quality is measured between the optical transponder included in the other optical communication device 10 and the first optical transponder 15a has been described. Similarly, communication quality can be measured between an optical transponder included in the other optical communication device 10 and any optical transponder. Further, communication qualities can be measured simultaneously for a plurality of pairs of optical transponders, and an optical signal transmitted from one optical transponder can be received by a plurality of optical transponders to measure one-to-many communication qualities.

In the optical communication device 10 according to the present embodiment, transmitting the optical signal input from the optical transponder to the second optical switch 17 from the seventh optical switch 17d to the noise addition unit 14 makes it possible to reduce the number of times the optical signal passes through the optical splitter as compared to transmitting the optical signal from the second optical splitter 17a to the noise addition unit 14, thereby increasing the allowable amount of noise to be added by the noise addition unit 14. Therefore, an available margin of additional noise for measuring the communication quality between the optical transponders included in each of two or more optical communication devices 10 is increased, thereby making it possible to more flexibly measure the communication quality.

In the first to fifth examples of the configuration of the optical communication device 10 described above, since the ports of the transponder-integrated optical switch 13 connected to the path selection optical switch 12 includes the optical splitters, C/D/C (Colorless, Directionless, and Contentionless) connection functions are not impaired for optical signals that do not pass through the noise addition unit 14.

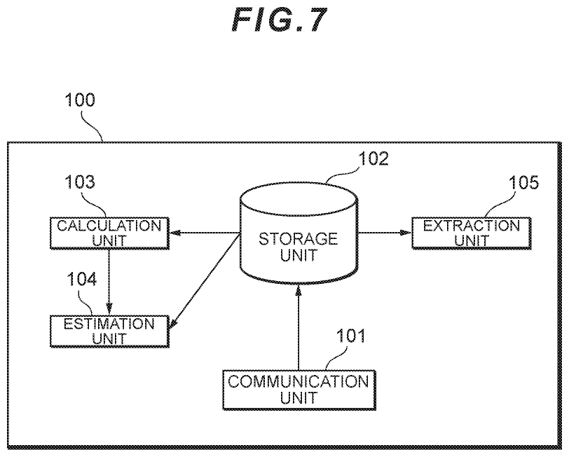

FIG. 7 is a diagram illustrating functional blocks of the management device 100 according to an embodiment of the present invention. The management device 100 includes a communication unit 101, a storage unit 102, a calculation unit 103, an estimation unit 104, and an extraction unit 105. The communication unit 101 is constructed from a communication interface, transmits, to the controller 11 of the optical communication device 10, setting information for a path through which an optical signal is transmitted, and receives information related to the measurement result of communication quality from the controller 11. The storage unit 102 stores a combination of types of optical transponders for which communication quality has already been measured among the plurality of optical transponders, together with the measurement result of communication quality related to the combination. The calculation unit 103 calculates a transmission characteristic of the path through which an optical signal is transmitted from one of the two optical communication devices 10 (hereinafter referred to as the first optical communication device) to the other (hereinafter referred to as the second optical communication device). The estimation unit 104 estimates the communication quality based on the measurement result of communication quality stored in the storage unit 102 and the transmission characteristic calculated by the calculation unit 103 when a combination of an optical transponder of the first optical communication device and an optical transponder of the second optical communication device is a combination of types of optical transponders for which communication quality has already been measured. The extraction unit 105 extracts the combination of types of optical transponders for which communication quality has not been measured from among the plurality of optical transponders. The calculation unit 103, the estimation unit 104, and the extraction unit 105 are functional units implemented by a processor included in the management device 100.

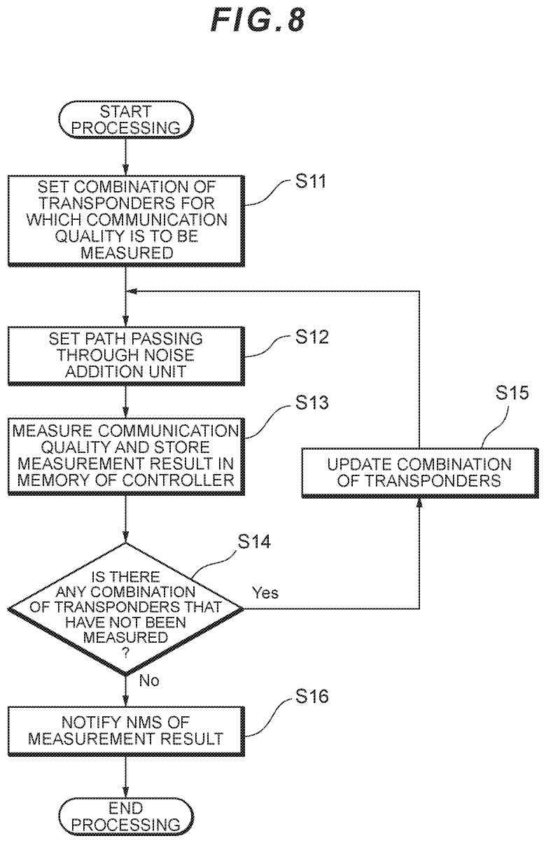

FIG. 8 is a flowchart of first processing executed by the optical communication system 1 according to an embodiment of the present invention. The first processing is processing executed by one optical communication device 10 and the management device 100 included in the optical communication system 1, and is also processing of measuring communication qualities between the plurality of optical transponders included in the optical communication device 10. The optical communication device 10 transmits an optical signal from one of two of the plurality of optical transponders to the other so as to pass the optical signal through the noise addition unit 14, and notifies the management device 100 of the measurement result of measuring the communication quality.

First, the optical communication device 10 sets a combination of optical transponders for which communication quality is to be measured among the plurality of optical transponders included in the optical communication device 10 (S11). Here, the combination of optical transponders for which communication quality is to be measured may be a combination of two optical transponders selected from among the plurality of optical transponders. If the optical communication device 10 includes N optical transponders, there are possible combinations of N(N−1)/2 at maximum. It is to be noted that the setting of the combination of optical transponders for which communication quality is to be measured may be performed by the management device 100.

Next, the optical communication device 10 sets a transmission path for optical signals such that the transmitted optical signals pass through the noise addition unit 14 at least once for the combination of optical transponders for which communication quality is to be measured (S12). The setting of the transmission path is performed by setting control signals for the first optical switch 16 and the second optical switch 17 included in the transponder-integrated optical switch 13. It is to be noted that the setting of the transmission path for optical signals may be performed by the management device 100.

The optical communication device 10 transmits and receives optical signals between the set pair of optical transponders through the set transmission path for the optical signals, measures the communication quality of the pair of optical transponders, and stores the measured communication quality in a memory of the controller 11 (S13). After that, it is determined whether or not there is any combination of optical transponders for which communication quality is to be measured (S14). If there is any combination of optical transponders for which communication quality is to be measured (S14: Yes), the setting of the combination of optical transponders is updated (S15), the transmission path for optical signals is newly set (S12), and then the communication quality is measured and stored in the memory of the controller 11 (S13).

On the other hand, if there is no combination of optical transponders for which communication quality is to be measured (S14: No), the management device 100 (NMS) is notified of a collection of the measurement results of communication quality (S16). The management device 100 stores the measurement results of communication quality in the storage unit 102 in association with the combinations of optical transponders on which the respective measurements have been performed. Thus, the first processing ends.

In the optical communication system 1 according to the present embodiment, it is possible for the management device 100 to collectively manage the measurement results obtained by measuring the communication qualities between the plurality of optical transponders included in the optical communication device 10, and in response to a request for checking the communication quality related to the same optical transponders from another optical communication device 10, it is possible to use the measurement results to check the communication quality more efficient. Further, the optical communication device 10 autonomously performing a series of processes such as setting of transmission path and measurement of communication quality makes it possible to measure the communication quality on demand without imposing a large processing load and communication load on the management device 100.

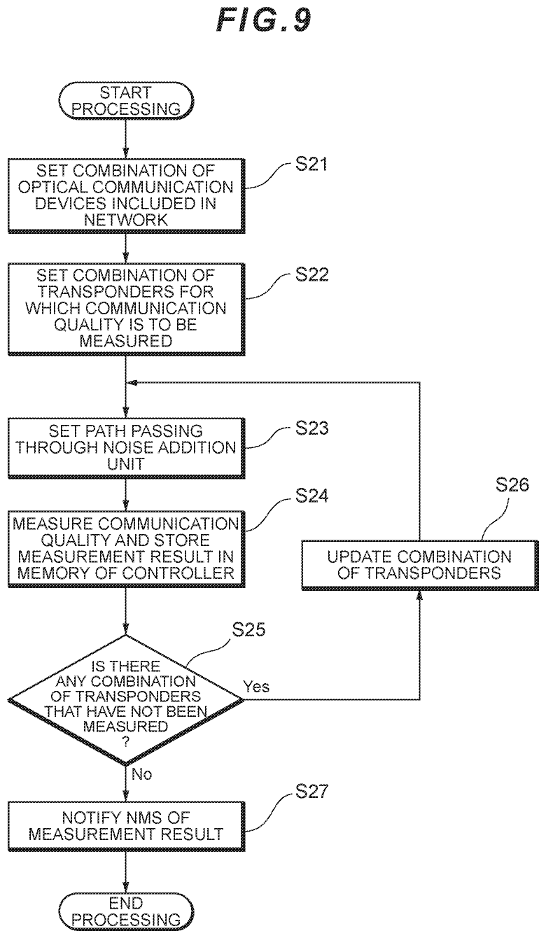

FIG. 9 is a flowchart of second processing executed by the optical communication system 1 according to an embodiment of the present invention. The second processing is processing executed by two optical communication devices 10 and the management device 100 included in the optical communication system 1, and is also processing of measuring communication qualities between the plurality of optical transponders included in the two optical communication devices 10. Hereinafter, one of the two optical communication devices 10 for which communication quality is to be measured is referred to as the first optical communication device, and the other is referred to as the second optical communication device. The first optical communication device transmits an optical signal from one of the plurality of optical transponders to the second optical communication device, and the second optical communication device transmits the optical signal through the noise addition unit 14 and receives the optical signal by one of the plurality of optical transponders. The first optical communication device and the second optical communication device each notify the management device 100 of the measurement result of measuring the communication quality.

First, the management device 100 sets a combination of optical communication devices 10 included in the communication network of the optical communication system 1 (S21). Here, the combination of optical communication devices 10 for which communication quality is to be measured may be a combination of two optical communication devices 10 selected from among the plurality of optical communication devices 10 included in the communication network. If the optical communication network includes N optical communication devices 10, there are possible combinations of N(N−1)/2 at maximum.

Next, the first optical communication device and the second optical communication device set a combination of optical transponders for which communication quality is to be measured among the plurality of optical transponders included in the first optical communication device and the second optical communication device (S22). It is to be noted that the setting of the combination of optical transponders for which communication quality is to be measured may be performed by the management device 100.

The management device 100 controls the path selection optical switch 12 of another optical communication device 10 interposed between the first optical communication device and the second optical communication device to set a transmission path for optical signals so that the optical signals are transmitted from the first optical communication device to the second optical communication device. Further, the first optical communication device and the second optical communication device set the transmission path for optical signals such that the transmitted optical signals pass through the noise addition unit 14 at least once for the pair of optical transponders for which communication quality is to be measured (S23). Here, the transmission path may be set so as to pass through the noise addition unit 14 in the second optical communication device on the reception side.

The first optical communication device and the second optical communication device transmit and receive optical signals between the set pair of optical transponders through the set transmission path for the optical signals, measure the communication quality of the pair of optical transponders, and store the measured communication quality in a memory of their own controller 11 (S24). After that, it is determined whether or not there is any combination of optical transponders for which communication quality is to be measured (S25). If there is any combination of optical transponders for which communication quality is to be measured (S25: Yes), the setting of the combination of optical transponders is updated (S26), the transmission path for optical signals is newly set (S23), and then the communication quality is measured and stored in the memory of the controller 11 (S24). It is to be noted that the measurement of communication quality may be performed in both directions or in one direction. When the setting of the combination of optical transponders is updated, the management device 100 may notify the first optical communication device and the second optical communication device of the update timing, or a master device may notify a slave device of the update timing where the relationship between the master device and the slave device is determined in advance between the first optical communication device and the second optical communication device.

On the other hand, if there is no combination of optical transponders for which communication quality is to be measured (S25: No), the first optical communication device and the second optical communication device notify the management device 100 (NMS) of a collection of the measurement results of communication quality (S27). The management device 100 stores the measurement results of communication quality in the storage unit 102 in association with the combinations of optical transponders on which the respective measurements have been performed. Thus, the second processing ends.

In the optical communication system 1 according to the present embodiment, it is possible for the management device 100 to collectively manage the measurement results obtained by measuring the communication qualities between the plurality of optical transponders included in the pair of optical communication devices 10, and in response to a request for checking the communication quality related to the same optical transponders from another pair of optical communication devices 10, it is possible to use the measurement results to check the communication quality more efficient. Further, adding noise in the optical communication device 10 on the reception side makes it possible to simplify the processing of measuring the communication quality as compared to adding noise in the optical communication device 10 on the transmission side because it is not necessary to transmit information such as the amount of noise to be added from the optical communication device 10 on the transmission side to the optical communication device 10 on the reception side.

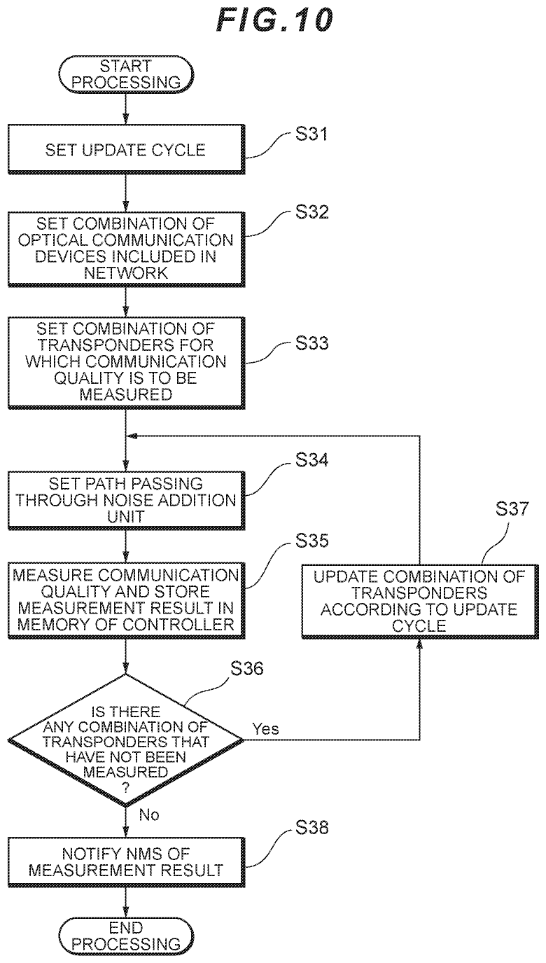

FIG. 10 is a flowchart of third processing executed by the optical communication system 1 according to an embodiment of the present invention. The third processing is processing executed by two optical communication devices 10 and the management device 100 included in the optical communication system 1, and is also processing of autonomously updating the pair of optical transponders to be measured by the two optical communication devices 10 and measuring the communication qualities between the plurality of optical transponders included in the two optical communication devices 10. Hereinafter, one of the two optical communication devices 10 for which communication quality is to be measured is referred to as the first optical communication device, and the other is referred to as the second optical communication device. The first optical communication device and the second optical communication device update a combination of a plurality of optical transponders for which communication quality is to be measured at a predetermined cycle, perform measurement of communication quality for each combination, and notify the management device 100 of the measurement result of measuring the communication quality.

First, the management device 100 sets an update cycle for measuring communication quality (S31). The update cycle is a cycle for updating the pair of optical transponders for which communication quality is to be measured, and can be any time cycle. It is to be noted that the update cycle may be set by the optical communication device 10.

First, the management device 100 sets a combination of optical communication devices 10 included in the communication network of the optical communication system 1 (S32). The first optical communication device and the second optical communication device, which are to be set, sets a combination of optical transponders for which communication quality is to be measured among their own optical transponders (S33). It is to be noted that the setting of the combination of optical transponders for which communication quality is to be measured may be performed by the management device 100.

The management device 100 controls the path selection optical switch 12 of another optical communication device 10 interposed between the first optical communication device and the second optical communication device to set a transmission path for optical signals so that the optical signals are transmitted from the first optical communication device to the second optical communication device. Further, the first optical communication device and the second optical communication device set the transmission path for optical signals such that the transmitted optical signals pass through the noise addition unit 14 at least once for the pair of optical transponders for which communication quality is to be measured (S34). Here, the transmission path may be set so as to pass through the noise addition unit 14 in the second optical communication device on the reception side.

The first optical communication device and the second optical communication device transmit and receive optical signals between the set pair of optical transponders through the set transmission path for the optical signals, measure the communication quality of the pair of optical transponders, and store the measured communication quality in a memory of their own controller 11 (S35). After that, it is determined whether or not there is any combination of optical transponders for which communication quality is to be measured (S36). If there is any combination of optical transponders for which communication quality is to be measured (S36: Yes), the first optical communication device and the second optical communication device update the setting of the combination of optical transponders according to the update cycle (S37), and set the transmission path for optical signals such that the transmitted optical signals pass through the noise addition unit 14 at least once for the updated and set pair of optical transponders (S34). Then, the communication quality is measured and stored in the memory of the controller 11 (S35).

On the other hand, if there is no combination of optical transponders for which communication quality is to be measured (S36: No), the first optical communication device and the second optical communication device notify the management device 100 (NMS) of a collection of the measurement results of communication quality (S38). The management device 100 stores the measurement results of communication quality in the storage unit 102 in association with the combinations of optical transponders on which the respective measurements have been performed. It is to be noted that the first optical communication device and the second optical communication device may be configured to screen the measurement results according to a predetermined criterion before notifying the management device 100 of the measurement results, and notify the management device 100 of the measurement results that satisfy the predetermined criterion. Thus, the third processing ends.

In the optical communication system 1 according to the present embodiment, the optical communication devices 10 of the pair can each update the pair of the optical transponders pair for which communication quality is to be autonomously measured, and notify the management device 100 of a collection of measurement results, thereby making it possible to reduce the processing load and communication load on the management device 100. Further, the first optical communication device and the second optical communication device screening the measurement results of communication quality and notifying the management device 100 of the screening results makes it possible to reduce the amount of information to be processed by the management device 100 and reduce the calculation load and communication load on the management device 100.

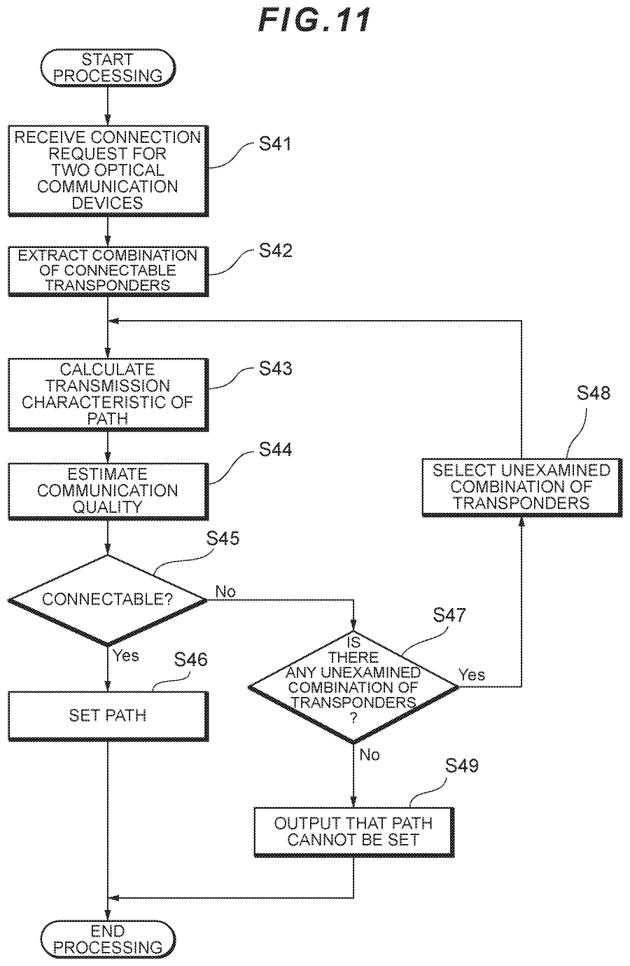

FIG. 11 is a flowchart of fourth processing executed by the optical communication system 1 according to an embodiment of the present invention. The fourth processing is processing executed by two optical communication devices 10 and the management device 100 included in the optical communication system 1, and is also processing of determining whether or not it is possible to ensure predetermined communication quality for the plurality of optical transponders included in the two optical communication devices 10, and setting (or not setting) a transmission path for optical signals based on the determination result. Hereinafter, one of the two optical communication devices 10 for which communication quality is to be measured is referred to as the first optical communication device, and the other is referred to as the second optical communication device.

First, the management device 100 receives a connection request from the two optical communication devices 10 (the first optical communication device and the second optical communication device) included in the optical communication system 1 (S41). Then, for the plurality of optical transponders included in the first optical communication device and the second optical communication device, a combination of types of optical transponders for which communication quality has already been measured is extracted as a combination of connectable optical transponders (S42).

Next, the management device 100 causes the calculation unit 103 to calculate a transmission characteristic of the path through which an optical signal is transmitted from the first optical communication device to the second optical communication device based on the transmission characteristics of another optical communication device 10 and the optical fiber F interposed between the first optical communication device and the second optical communication device (S43). In addition, the management device 100 causes the estimation unit 104 to estimate the communication quality of the pair of optical transponders based on the measurement result of communication quality of the pair of optical transponders stored in the storage unit 102 and the transmission characteristic calculated by the calculation unit 103 (S44).

The management device 100 determines, based on the estimated communication quality, whether or not communication satisfying predetermined communication quality can be performed by the pair of optical transponders, and determines whether or not the first optical communication device and the second optical communication device are connectable (S45). If it is determined that they are connectable (S45: Yes), the management device 100 controls the path selection optical switch 12 of another optical communication device 10 interposed between the first optical communication device and the second optical communication device to set a transmission path for optical signals so that the optical signals are transmitted from the first optical communication device to the second optical communication device.

On the other hand, if it is determined that they are not connectable for the pair of optical transponders for which communication quality is to be estimated (S45: No), it is determined whether or not there is any combination of optical transponders that has not been examined (S46). If there is any combination of optical transponders that has not been examined (S46: Yes), the calculation unit 103 calculates the transmission characteristic of the transmission path (S43), the estimation unit 104 estimates the communication quality (S44), and it is determined whether or not the first optical communication device and the second optical communication device are connectable (S45). It is to be noted that, if there is no substantial change in the transmission characteristic of the transmission path, the calculation of the transmission characteristic by the calculation unit 103 may be omitted and an already-calculated transmission characteristic may be used.

If it is determined that the pair of optical transponders for which communication quality is to be estimated is not connectable (S45: No) and it is determined that there is no unexamined combination of optical transponders (S46: No), the management device 100 outputs information indicating that a transmission path that satisfies the predetermined communication quality cannot be set between the first optical communication device and the second optical communication device (S49). Thus, the fourth processing ends.

In the optical communication system 1 according to the present embodiment, even when the combination of types of optical transponders for which communication quality has already been measured is connected via a network structure different from that when the communication quality is measured, it is possible to perform estimation of communication quality. Therefore, it is not necessary to measure the communication quality for each of the different network structures, it is possible to reduce the number of times of performing the processing of measuring the communication quality, and reduce the calculation load and communication load on the optical communication devices 10 and the management device 100.

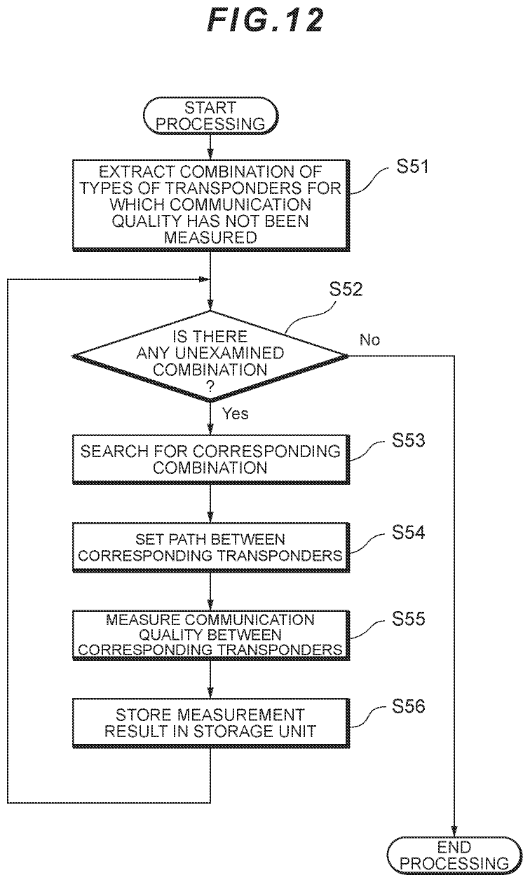

FIG. 12 is a flowchart of fifth processing executed by the optical communication system 1 according to an embodiment of the present invention. The fifth processing is processing executed by two optical communication devices 10 and the management device 100 included in the optical communication system 1, and is also processing of extracting a combination of types of optical transponders for which communication quality has not been measured among the plurality of optical transponders, and measuring the communication quality for the extracted pair of optical transponders. Hereinafter, one of the two optical communication devices 10 for which communication quality is to be measured is referred to as the first optical communication device, and the other is referred to as the second optical communication device.

First, the management device 100 causes the extraction unit 105 to extract the combination of types of optical transponders for which communication quality has not been measured from among the plurality of optical transponders (S51). It is to be noted that, if there is no combination of types of optical transponders for which communication quality has not been measured, the fifth processing may end (S52: No).

If there is any combination of types of optical transponders for which communication quality has not been measured (S52: Yes), the management device 100 searches for a first optical communication device and a second optical communication device that include a combination of optical transponders for which communication quality has not been measured (S53). It is to be noted that, if one optical communication device 10 includes a combination of optical transponders for which communication quality has not been measured, the management device 100 has only to search for the one optical communication device 10.

Next, the management device 100 controls the path selection optical switch 12 of another optical communication device 10 interposed between the first optical communication device and the second optical communication device so that optical signals are transmitted between the pair of optical transponders, for which communication quality has not been measured, of the first optical communication device and the second optical communication device that are searched for, to set a transmission path for optical signals from the first optical communication device to the second optical communication device. Then, the first optical communication device and the second optical communication device set the transmission path such that the pair of optical transponders can transmit and receive optical signals. Here, the transmission path may be set so as to pass through the noise addition unit 14 of the second optical communication device on the reception side.

The first optical communication device and the second optical communication device measure the communication quality of the pair of optical transponders using the set transmission path, and notify the management device 100 of the measurement result. The management device 100 stores the measurement result in the storage unit 102 in association with the pair of optical transponders (S56). In addition, it is determined whether there is any combination of types of optical transponders for which communication quality has not been measured (S52), and the measurement processing is repeated until there is no combination of types of optical transponder for which communication quality has not been measured. Thus, the fifth processing ends.

In the optical communication system 1 according to the present embodiment, it is possible to reduce the number of combinations of types of optical transponders for which communication quality has not been measured, and increase the number of combinations of types of optical transponders for which communication quality can be estimated. As a result, it is possible to reduce the number of times of performing the processing of measuring the communication quality, and reduce the calculation load and communication load on the optical communication devices 10 and the management device 100.

The embodiments described above are for facilitating the understanding of the present invention, and are not intended to limit the present invention. The respective elements included in the embodiments and their arrangement, material, condition, shape, size, and the like are not limited to those illustrated, and can be changed as appropriate. Further, the configurations presented in different embodiments can be partially replaced or combined.

### REFERENCE SIGNS LIST

1 Optical communication system
10 Optical communication device
11 Controller
12 Path selection optical switch
13 Transponder-integrated optical switch
14 Noise addition unit
15 Transponder bank
15a First optical transponder
15b Second optical transponder
15c Third optical transponder
15d Fourth optical transponder
16 First optical switch
16a First optical splitter
16b Fifth optical switch
16c Fourth optical switch
17 Second optical switch
17a Second optical splitter
17b Sixth optical switch
17c Eighth optical switch
17d Seventh optical switch
18 Third optical switch
100 Management device
101 Communication unit
102 Storage unit
103 Calculation unit
104 Estimation unit
F Optical fiber

1. An optical communication device, comprising:
a plurality of optical transponders configured to perform mutual conversion between an optical signal and an electrical signal;
a noise addition unit configured to add noise that degrades signal quality to an input optical signal and output the resulting optical signal;
a first optical switch configured to output an optical signal input from outside or the noise addition unit to at least one of the plurality of optical transponders; and
a second optical switch configured to directly or indirectly output an optical signal input from the at least one of the plurality of optical transponders to outside or the noise addition unit.

2. The optical communication device according to claim 1, further comprising:
a third optical switch configured to output the input optical signal to the noise addition unit, wherein
the first optical switch outputs the optical signal input from the outside or the noise addition unit to one of the plurality of optical transponders or the third switch, and
the second optical switch outputs the optical signal input from one of the plurality of optical transponders to the outside or the third optical switch.

3. The optical communication device according to claim 1, wherein
the first optical switch outputs the optical signal input from the outside or the noise addition unit to one of the plurality of optical transponders or the second switch, and
the second optical switch outputs the optical signal input from one of the plurality of optical transponders or the first optical switch to the outside or the noise addition unit.

4. The optical communication device according to claim 1, wherein
the first optical switch includes
a plurality of first optical splitters configured to divide the optical signal input from outside,
a fourth optical switch configured to output the optical signal input from the noise addition unit to a selected output destination, and
a plurality of fifth optical switches each configured to output the optical signal input from one of the plurality of first optical splitters or the fourth optical switch to at least one of the plurality of optical transponders.

5. The optical communication device according to claim 1, wherein
the second optical switch includes
a plurality of sixth optical switches configured to output the optical signals input from the plurality of optical transponders to selected output destinations,
a plurality of second optical splitters configured to divide the optical signals input from the plurality of sixth optical switches to outside, and
a seventh optical switch configured to output the optical signals input from the plurality of sixth optical switches to the noise addition unit.

6. The optical communication device according to claim 1, further comprising:
a controller configured to control the plurality of optical transponders, the noise addition part, the first optical switch, and the second optical switch.

7. An optical communication system, comprising:
the optical communication device according to claim 1; and
a management device configured to manage the optical communication device,
wherein
the optical communication device transmits the optical signal from one of two optical transponders of the plurality of optical transponders to the other via the noise addition unit to notify the management device of a measurement result of measuring communication quality.

8. The optical communication system comprising:
a first optical communication device and a second optical communication device that are each the optical communication device according to claim 1, and
a management device configured to manage the first optical communication device and the second optical communication device, wherein
the first optical communication device transmits an optical signal from one of the plurality of optical transponders to the second optical communication device, and
the second optical communication device transmits the optical signal through the noise addition unit and receives the optical signal by one of the plurality of optical transponders, and
the first optical communication device and the second optical communication device each notify the management device of the measurement result of measuring communication quality.

9. The optical communication system according to claim 8, wherein
the first optical communication device and the second optical communication device update a combination of the plurality of optical transponders for which communication quality is to be measured at a predetermined cycle, and performs measurement of communication quality for each combination, and
the first optical communication device and the second optical communication device each notify the management device of the measurement result of measuring communication quality.

10. The optical communication system according to claim 8, wherein
the management device includes
a storage unit configured to store a combination of types of optical transponders for which communication quality has already been measured among the plurality of optical transponders, together with a measurement result of communication quality related to the combination;
a calculation unit configured to calculate a transmission characteristic of a path through which an optical signal is transmitted from the first communication device to the second optical communication device; and
an estimation unit configured to estimate the communication quality based on the measurement result of communication quality stored in the storage unit and the transmission characteristic calculated by the calculation unit when a combination of an optical transponder of the first optical communication device and an optical transponder of the second optical communication device is the combination of types of optical transponders for which communication quality has already been measured.

11. The optical communication system according to claim 10, wherein
the management device further includes an extraction unit configured to extract a combination of types of optical transponders for which communication quality has not been measured among the plurality of optical transponders, and
the management device causes one or both of the first optical communication device and the second optical communication device to perform measurement of communication quality on the combination of types of optical transponders extracted by the extraction unit to store the measurement result of communication quality in the storage unit.
